(19) United States
(12) Patent Application Publication
(10) Pub. No.: US 2016/0013480 A1
(43) Pub. Date: Jan. 14, 2016

(54) MULTI-LAYER BATTERY ELECTRODE DESIGN FOR ENABLING THICKER ELECTRODE FABRICATION

(71) Applicant: Applied Materials, Inc., Santa Clara, CA (US)

(72) Inventors: Godfrey SIKHA, Santa Clara, CA (US); Subramanya P. HERLE, Mountain View, CA (US); Connie P. WANG, Mountain View, CA (US); Zheng WANG, Mountain View, CA (US); Dongli ZENG, Sunnyvale, CA (US); Fei C. WANG, Fremont, CA (US); Mahendra C. ORILALL, Santa Clara, CA (US)

(21) Appl. No.: 14/771,126

(22) PCT Filed: Mar. 5, 2014
(86) PCT No.: PCT/US2014/020788

§ 371 Date: Aug. 27, 2015

Related U.S. Application Data
(60) Provisional application No. 61/790,684, filed on Mar. 15, 2013.

(51) Int. Cl. H01M 4/36; H01M 4/131; H01M 4/136; H01M 4/1391; H01M 4/58; H01M 4/485; H01M 4/505; H01M 4/525; H01M 4/04; H01M 4/62

(52) U.S. Cl. CPC H01M 4/366; H01M 4/0404; H01M 4/131; H01M 4/136; H01M 4/623; H01M 4/5825; H01M 4/485; H01M 4/505; H01M 4/525; H01M 4/0435; H01M 4/1391; H01M 4/0409; H01M 2004/028

(57) ABSTRACT

Implementations of the present invention relate generally to high-capacity energy storage devices and methods and apparatus for fabricating high-capacity energy storage devices. In one implementation, a method for forming a multi-layer cathode structure is provided. The method comprises providing a conductive substrate, depositing a first slurry mixture comprising a cathodically active material to form a first cathode material layer over the conductive substrate, depositing a second slurry mixture comprising a cathodically active material to form a second cathode material layer over the first cathode material layer, and compressing the as-deposited first cathode material layer and the second cathode material layer to achieve a desired porosity.

### BACKGROUND

1. Field

Implementations of the present invention relate generally to high-capacity energy storage devices and methods and apparatus for fabricating high-capacity energy storage devices.

2. Description of the Related Art

Fast-charging, high-capacity energy storage devices, such as supercapacitors and lithium-ion (Li-ion) batteries, are used in a growing number of applications, including portable electronics, medical, transportation, grid-connected large energy storage, renewable energy storage, and uninterruptible power supply (UPS).

Contemporary, secondary and rechargeable energy storage devices typically include an anode electrode, a cathode electrode, a separator positioned between the anode electrode and the cathode electrode, and at least one current collector. Examples of materials for the positive current collector (the cathode) typically include aluminum (Al), stainless steel (SST), and nickel (Ni). Examples of materials for the negative current collector (the anode) typically include copper (Cu), but stainless steel (SST), and nickel (Ni) may also be used.

The active cathode material of a Li-ion battery is typically selected from a wide range of lithium transition metal oxides. Examples include oxides with spinel structures (LiMn₂O₄ (LMO)), LiNi_{0.5}Mn_{1.5}O₄ (LMNO), layered structures (LiCoO₂, lithium nickel-manganese-cobalt oxides (NMC)), lithium nickel-cobalt-aluminum oxides (NCA)), olivine structures (e.g., LiFePO₄), and combinations thereof.

The active anode material is generally carbon based, either graphite or hard carbon, with particle sizes about 5-15 um. Silicon (Si) and tin (Sn)-based active materials are currently being developed as next generation anode materials. Both have significantly higher capacity than carbon based electrodes. Li₁₅Si₄ has a capacity of about 3,580 mAh/g, whereas graphite has a capacity less than 372 mAh/g. Sn-based anodes can achieve capacities over 900 mAh/g, which are much higher than most cathode materials can achieve. Thus, it is expected that cathodes will continue to be heavier than anodes in a balanced lithium ion cell.

Currently, the active materials only account for <50 wt % of the overall components of battery cells. The ability to manufacture thicker electrodes containing more active materials would significantly increase the battery energy density and reduce the production costs for battery cells by reducing the percentage contribution from inactive elements. However, the thickness of electrodes is currently limited by both the utilization and the mechanical properties of the materials currently used.

Accordingly, there is a need in the art for faster charging, higher capacity energy storage devices that are smaller, lighter, and can be more cost effectively manufactured at a high production rate.

### SUMMARY

Implementations of the present invention relate generally to high-capacity energy storage devices and methods and apparatus for fabricating high-capacity energy storage devices. In one implementation, a method for forming a multi-layer cathode structure is provided. The method comprises providing a conductive substrate, depositing a first slurry mixture comprising a cathodically active material to form a first cathode material layer over the conductive substrate, depositing a second slurry mixture comprising a cathodically active material to form a second cathode material layer over the first cathode material layer, and compressing the as-deposited first cathode material layer and the second cathode material layer to achieve a desired porosity.

### BRIEF DESCRIPTION OF THE DRAWINGS

So that the manner in which the above recited features of the present invention can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1A is a schematic diagram of a partial battery cell with dual-sided electrodes having one or more electrode structures formed according to implementations described herein;

FIG. 1B is a schematic diagram of a partial battery cell with single side electrodes having one or more electrode structures formed according to implementations described herein;

FIGS. 2A-2C are schematic cross-sectional views of one implementation of a partial multi-layer cathode electrode structure formed according to implementations described herein;

FIG. 3 is a process flow chart summarizing one implementation of a method for forming a multi-layer cathode electrode structure according to implementations described herein;

FIGS. 4A-4D are schematic cross-sectional views of one implementation of a partial multi-layer cathode electrode structure formed according to implementations described herein;

FIG. 5 is a process flow chart summarizing one implementation of a method for forming a partial multi-layer cathode electrode structure according to implementations described herein;

FIGS. 6A-6F are schematic cross-sectional views of one implementation of a partial multi-layer cathode electrode structure formed according to implementations described herein; and

FIG. 7 is a process flow chart summarizing one implementation of a method for forming a multi-layer cathode electrode structure according to implementations described herein.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Implementations of the present invention relate generally to high-capacity energy storage devices and methods and apparatus for fabricating high-capacity energy storage devices. One typical cathode material for high energy density batteries is Li(NiₓMn_{y}Co_{z})O₂ (X+Y+Z=1), e.g., lithium nickel-manganese-cobalt oxide or “NMC”. Anode materials are typically graphite based. Both NMC and graphite electrodes are porous, with typical porosities ranging between 25 to 35%. The porous spaces may be filled with electrolyte. Exemplary electrolytes may contain solvents and lithium salts, such as ethyl carbonate/diethyl carbonate “EC/DEC” solvent with LiPF₆ salt. During discharge processes, Li-ions diffuse out of lithiated graphite particles. The Li-ions then diffuse through the electrolyte filling porous space between graphite particles and through the separator to reach the cathode. Li-ions then diffuse through electrolyte between cathode particles, and eventually intercalate cathode particles.

To increase battery cell energy density, it is highly desirable to “pack” more materials into each battery cell to increase the electrode loading (mAh/cm²). One method for increasing electrode loading is to increase the amount of active materials per unit electrode area, i.e., make thicker electrodes and/or increase the density of the electrode materials. However, current production processes for producing thicker electrodes are not only cumbersome but also produce electrodes which suffer from lack of adhesion, lack of cohesion and cycling fatigue.

In certain implementations described herein, multi-layer battery electrode designs for enabling thicker electrode fabrication are provided. In certain implementations not only are thicker/denser electrodes provided but processes for producing thicker electrodes with reduced production time are also provided. In certain implementations, the multilayer electrodes have different properties (e.g., porosity, surface area, electrode composition) in each layer, or the multilayer electrodes have different active material chemistries in each layer. For example, the layers of the multi-layer electrode may vary relative to the other layers in at least one of: the slurry composition used to form each layer, the porosity of each layer, the active material used to form each layer, the particle size of the active material particles, the modal particle size distribution of the particles in each layer, and the tap density of the active materials.

It is believed that these multi-layer battery electrode designs described herein will yield (i) higher power (ii) longer cycle compared to a single layer electrode having uniform properties.

Although discussed as a two layer structure is some implementations, it should be understood that any number of layers comprising different materials, particle sizes, and/or density may be used to form the porous cathode structures described herein. In certain implementations where a dual sided electrode is formed, each porous layer may be simultaneously deposited on opposing sides of the substrate using a dual-sided deposition process.

The multi-layer electrode designs described herein include the following electrode structures: (i) two or more electrode layers including different slurry compositions in each layer leading to different porosities between the layers, (ii) two or more electrode layers including different active materials in each layer, (iii) two or more electrode layers including different particle size of the same active material in each layer leading to different surface areas and/or different porosities between the layers, (iv) two or more electrode layers including different particle size distribution (e.g., uni-modal, bi-modal, multi-modal) between the layers, (v) two or more electrode layers including different electrode compositions (binder, conductive additive, active material) in each layer, (vi) two or more electrode layers having materials with different tap densities, and any combinations of (i)-(vi). Different process techniques may also be used to form the layers listed about in (i)-(vi).

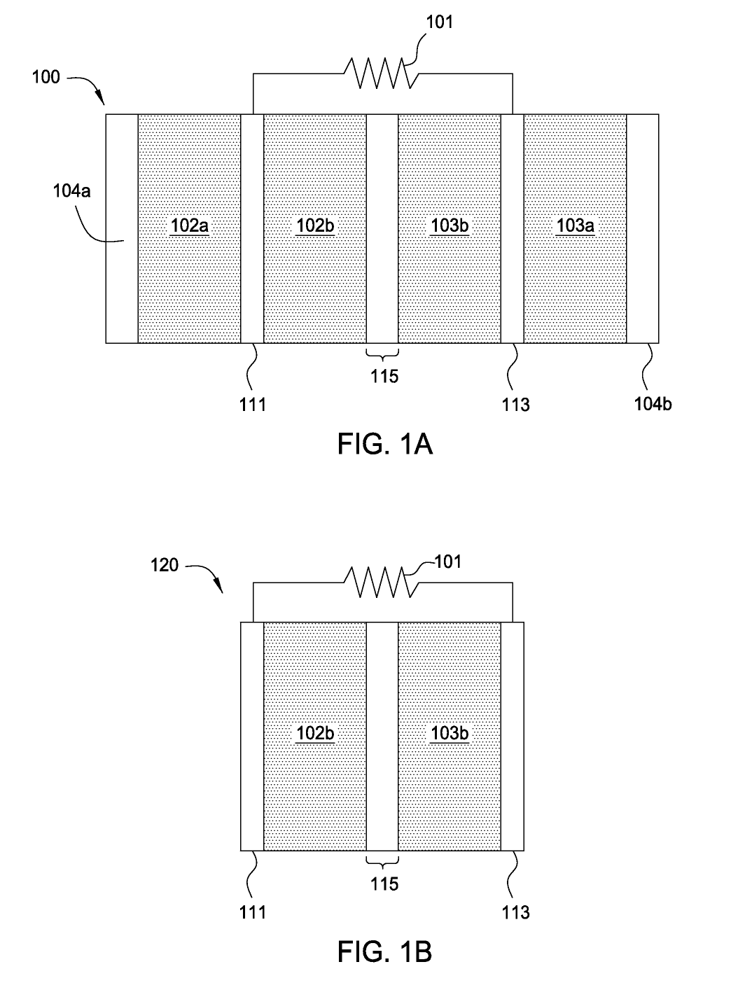

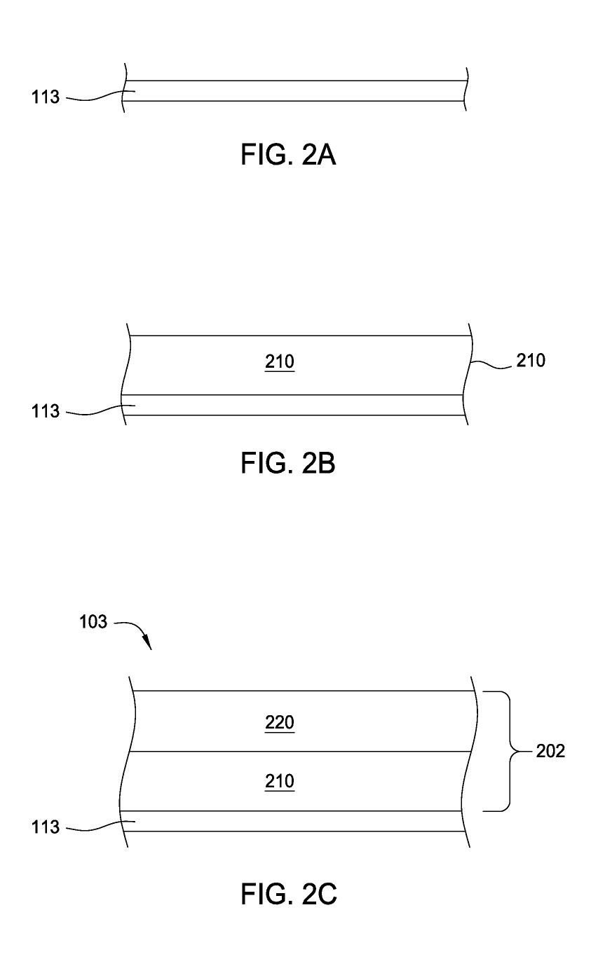

FIG. 1A is a schematic diagram of a partial battery cell 100 with dual-sided electrodes having one or more electrode structures (anode 102a, 102b and/or cathode 103a, 103b) formed according to implementations described herein. The partial battery cell bi-layer 100 may be a Li-ion battery cell bi-layer. The cathode structure 103 (103a and 103b) may be any of the multi-layer electrode structures described herein. FIG. 1B is a schematic diagram of a partial battery cell 120 having one or more electrode structures formed according to implementations described herein. The partial battery cell bi-layer 120 may be a Li-ion battery cell bi-layer. The battery cells 100, 120 are electrically connected to a load 101 according to one implementation described herein. The primary functional components of the battery cell bi-layer 100 include anode structures 102a, 102b, cathode structures 103a, 103b, separator layers 104a, 104b, and 115, current collectors 111 and 113 and optionally an electrolyte (not shown) disposed within the region between the separator layers 104a, 104b. The primary functional components of the battery cell 120 include anode structure 102b, cathode structure 103b, the separator 115, current collectors 111 and 113 and an optional electrolyte (not shown) disposed within the region between the current collectors 111, 113. A variety of materials may be used as the electrolyte, for example, a lithium salt in an organic solvent. The battery cells 100, 120 may be hermetically sealed in a suitable package with leads for the current collectors 111 and 113.

The anode structures 102a, 102b, cathode structures 103a, 103b, and separator layers 104a, 104b and 115 may be immersed in the electrolyte in the region formed between the separator layers 104a and 104b. It should be understood that a partial exemplary structure is shown and that in certain implementations, additional anode structures, cathode structures, and current collectors may be added to the structure.

Anode structure 102b may include a metal anodic current collector 111 and an active material formed according to implementations described herein. The anode structure may be porous. Other exemplary active materials include graphitic carbon, lithium, tin, silicon, aluminum, antimony, tin-boron-cobalt-oxide, and lithium-cobalt-nitride (e.g., Li₃₋₂ₓCoₓN (0.1≦x≦0.44)). Similarly, cathode structure 103b may include a cathodic current collector 113 respectively and a second active material formed according to implementations described herein. The current collectors 111 and 113 are made of electrically conductive material such as metals. In one implementation, the anodic current collector 111 comprises copper and the cathodic current collector 113 comprises aluminum. The separator 115 is used to prevent direct electrical contact between the components in the anode structure 102b and the cathode structure 103b. The separator 115 may be porous.

Active materials on the cathode side of the battery cell 100, 120 or positive electrode, may comprise a lithium-containing metal oxide, such as lithium cobalt dioxide (LiCoO₂) or lithium manganese dioxide (LiMnO₂), LiCoO₂, LiNiO₂, LiNiₓCo_{y}O₂ (e.g., LiNi_{0.8}Co_{0.2}O₂) LiNiₓCo_{y}Al_{z}O₂ (e.g., LiNi_{0.8}Co_{0.15}Al_{0.05}O₂), LiMn₂O₄, LiₓMg_{y}Mn_{z}O₄ (e.g., LiMg_{0.5}Mn_{1.5}O₄), LiNiₓMn_{y}O₂ (e.g., LiNi_{0.5}Mn_{1.5}O₄), LiNiₓMn_{y}Co_{z}O₂ (e.g., LiNiMnCoO₂) (NMC), lithium-aluminum-manganese-oxide (e.g., LiAlₓMn_{y}O₄) and LiFePO₄. The active materials may be made from a layered oxide, such as lithium cobalt oxide, an olivine, such as lithium iron phosphate, or a spinel, such as lithium manganese oxide. In non-lithium implementations, an exemplary cathode may be made from TiS₂ (titanium disulfide). Exemplary lithium-containing oxides may be layered, such as lithium cobalt oxide (LiCoO₂), or mixed metal oxides, such as LiNiₓCo₁₋₂ₓMnₓO₂, LiNi_{0.5}Mn_{1.5}O₄, Li(Ni_{0.8}Co_{0.15}Al_{0.05})O₂, LiMn₂O₄. Exemplary phosphates may be iron olivine (LiFePO₄) and it is variants (such as LiFe₁₋ₓMgₓPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

Active materials on the anode side or negative electrode of the battery cell 100, 120, may be made from materials such as, for example, graphitic materials and/or various fine powders, and for example, microscale or nanoscale sized powders. Additionally, silicon, tin, or lithium titanate (Li₄Ti₅O₁₂) may be used with, or instead of, graphitic materials to provide the conductive core anode material. Exemplary cathode materials, anode materials, and methods of application are further described in commonly assigned United States Patent Application Publication No. US 2011/0129732, filed Jul. 19, 2010 titled COMPRESSED POWDER 3D BATTERY ELECTRODE MANUFACTURING, and commonly assigned United States Patent Application Publication No. US 2011/0168550, filed Jan. 13, 2010, titled GRADED ELECTRODE TECHNOLOGIES FOR HIGH ENERGY LITHIUM-ION BATTERIES.

It should also be understood that although a battery cell bi-layer 100 is depicted in FIGS. 1A and 1B, the implementations described herein are not limited to Li-ion battery cell bi-layer structures. It should also be understood, that the anode and cathode structures may be connected either in series or in parallel.

As used herein, the term “cathode material” includes at least one of the cathodically active material, binding agents, binding precursors, and electro-conductive material.

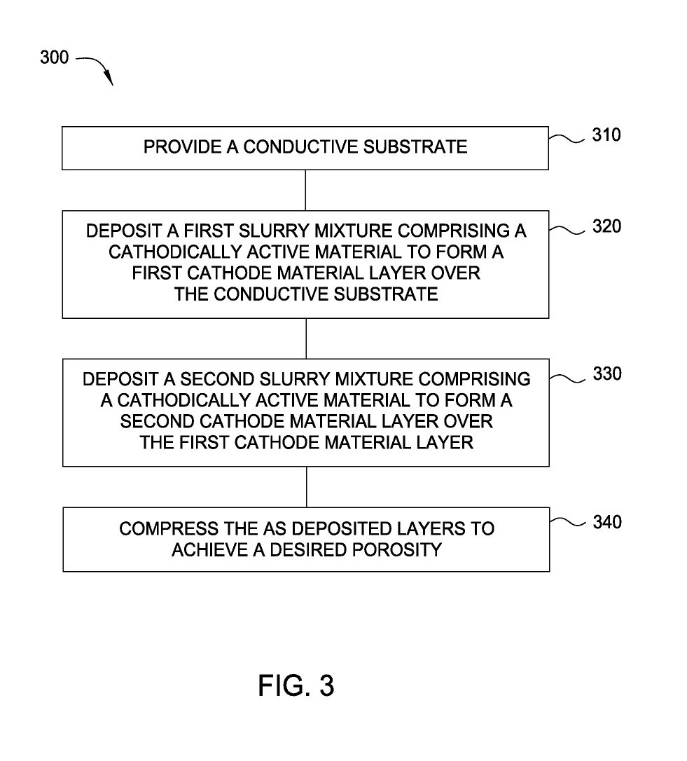

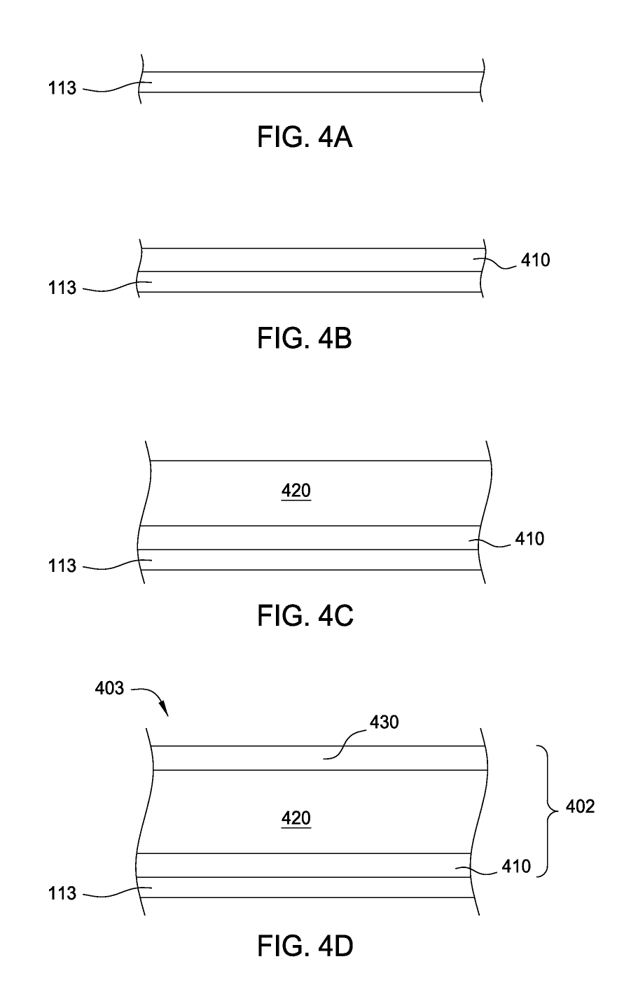

FIGS. 2A-2C are schematic cross-sectional views of one implementation of a partial multi-layer cathode electrode structure 103 formed according to implementations described herein. FIG. 3 is a process flow chart 300 summarizing one implementation of a method for forming a multi-layer cathode electrode structure according to implementations described herein. The multi-layer electrode structure 103 of FIGS. 2A-2C will be discussed with reference to the process flow chart 300.

At block 310, a conductive substrate is provided. The conductive substrate may be similar to current collector 113. As depicted in FIG. 2A, the current collector 113 is schematically illustrated prior to the deposition of the multi-layer cathode material 202 on the current collector 113. In one implementation, the current collector 113 is a conductive substrate (e.g., metallic foil, sheet, or plate). In one implementation, the current collector 113 is a flexible conductive substrate (e.g., a metallic foil). In one implementation, the current collector 113 is a conductive substrate with an insulating coating disposed thereon. In one implementation, the current collector 113 may include a relatively thin conductive layer disposed on a host substrate comprising one or more conductive materials, such as a metal, plastic, graphite, polymers, carbon-containing polymer, composites, or other suitable materials. Examples of metals that current collector 113 may be comprised of include aluminum (Al), copper (Cu), zinc (Zn), nickel (Ni), cobalt (Co), tin (Sn), manganese (Mn), magnesium (Mg), alloys thereof, and combinations thereof. In one implementation, the current collector 113 is perforated.

Alternatively, current collector 113 may comprise a host substrate that is non-conductive, such as a glass, silicon, and plastic or polymeric substrate that has an electrically conductive layer formed thereon by means known in the art, including physical vapor deposition (PVD), electrochemical plating, electroless plating, and the like. In one implementation, current collector 113 is formed out of a flexible host substrate. The flexible host substrate may be a lightweight and inexpensive plastic material, such as polyethylene, polypropylene or other suitable plastic or polymeric material, with a conductive layer formed thereon. In one implementation, the conductive layer is between about 10 and 15 microns thick in order to minimize resistive loss. Materials suitable for use as such a flexible substrate include a polyimide (e.g., KAPTON™ by DuPont Corporation), polyethylene terephthalate (PET), polyacrylates, polycarbonate, silicone, epoxy resins, silicone-functionalized epoxy resins, polyester (e.g., MYLAR™ by E.I. du Pont de Nemours & Co.), APICAL AV manufactured by Kanegaftigi Chemical Industry Company, UPILEX manufactured by UBE Industries, Ltd.; polyethersulfones (PES) manufactured by Sumitomo, a polyetherimide (e.g., ULTEM by General Electric Company), and polyethylene naphthalene (PEN). Alternately, the flexible substrate may be constructed from a relatively thin glass that is reinforced with a polymeric coating.

In one implementation, the current collector 113 is treated prior to formation of the multi-layer cathode material 202 to improve contact resistance and adhesion of the electrode to the current collector 113.

At block 320 a first slurry mixture comprising a cathodically active material is deposited on the current collector 113 to form a first cathode material layer 210 over the current collector 113 as shown in FIG. 2B. In one implementation, the first cathode material layer 210 has a thickness between about 10 μm to about 150 μm. In one implementation, the first cathode material layer 210 has a thickness between about 50 μm to about 100 μm. In implementations where the current collector 113 is a porous structure, the first cathode material layer 210 may be deposited within the pores of the current collector 113.

The first slurry mixture may be deposited onto the substrate using any of the following deposition techniques: spray deposition techniques, slide coating techniques, curtain coating techniques, slit coating techniques, fluidized bed coating techniques, roll coating techniques including patterned roll coating techniques (e.g., wire wound, knurl and gravure), dip coating, printing techniques (e.g., lithography and extrusion printing), and doctor blading techniques. Spray deposition techniques include, but are not limited to, hydraulic spray techniques, pneumatic spray techniques, atomizing spray techniques, electro-spray techniques, electrostatic spray techniques, plasma spray techniques, and thermal or flame spray techniques.

The first slurry mixture may comprise cathodically active materials and at least one of a binder, electro-conductive material and a solvent.

Exemplary cathodically active materials include lithium cobalt oxide (LiCoO₂), lithium manganese dioxide (LiMnO₂), titanium disulfide (TiS₂), LiNiₓCo₁₋₂ₓMnₓO₂ (“NMC”), LiMn₂O₄, iron olivine (LiFePO₄) and it is variants (such as LiFe₁₋ₓMgₓPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, composites thereof and combinations thereof.

The first slurry mixture may comprise between about 30 wt. % and about 96 wt. % of the cathodically active material. The first slurry mixture may comprise between about 75 wt. % and about 96 wt. % of the cathodically active material. The first slurry mixture may comprise between about 85 wt. % and about 92 wt. % of the cathodically active material. The first slurry mixture may comprise between about 50-80 wt. % of solids with about 75-98 wt. % of the solids being the cathodically active material. The slurry mixture may comprise between about 55-65 wt. % of solids with about 85-95 wt. % of the solids being the cathodically active material.

In one implementation, the cathodically active material is in the form of particles. In one implementation, the particles are nanoscale particles. In one implementation, the nanoscale particles have a diameter between about 1 nm and about 100 nm. In one implementation, the particles are micro-scale particles. In one implementation, the particles include aggregated micro-scale particles. In one implementation, the micro-scale particles have a diameter between about 1 μm and about 20 μm. In one implementation, the micro-scale particles have a diameter between about 2 μm and about 15 μm. In certain implementations it is desirable to select a particle size that maintains the packing density of the particles while maintaining a reduced surface area in order to avoid unwanted side reactions which may occur at higher voltages. In certain implementations, the particle size may depend on the type of cathodically active material used.

The first slurry mixture may further comprise a solid binding agent or precursors for forming a solid binding agent. The binding agent facilitates binding of the cathodically active material with the substrate and with other particles of the cathodically active material. The binding agent is typically a polymer. The binding agent may be soluble in a solvent. The binding agent may be a water-soluble binding agent. The binding agent may be soluble in an organic solvent. Exemplary binding agents include styrene butadiene rubber (SBR), carboxymethylcellulose (CMC), polyvinylidene fluoride (PVDF) and combinations thereof. The solid binding agent may be blended with the cathodically active material prior to deposition on the currently collector 113. The solid binding agent may be deposited on the current collector either prior to or after deposition of the cathodically active material. The solid binding agent may comprise a binder, such as a polymer, to hold the cathodically active material on the surface of the current collector 113. The binding agent will generally have some electrical or ionic conductivity to avoid diminishing the performance of the deposited layer, however most binding agents are usually electrically insulating and some materials do not permit the passage of lithium ions. In certain implementations, the binding agent is a carbon containing polymer having a low molecular weight. The low molecular weight polymer may have a number average molecular weight of less than about 10,000 to promote adhesion of the cathodically active material to the current collector 113.

The first slurry mixture may comprise between about 0.5 wt. % and about 15 wt. % of the binding agent. The slurry mixture may comprise between about 1 wt. % and about 4 wt. % of the binding agent. The first slurry mixture may comprise between about 50-80 wt. % of solids with the solids comprising about 1-10 wt. % of the binding agent. The slurry mixture may comprise between about 55-65 wt. % of solids with the solids comprising about 1-4 wt. % of the binding agent.

The first slurry mixture may further comprise electro-conductive materials for providing a conductive path between the highly resistive particles of the cathodically active materials. In one implementation, the electro-conductive materials may be selected from the group comprising: graphite, graphene hard carbon, acetylene black (AB), carbon black (CB), carbon coated silicon, tin particles, tin oxide, silicon carbide, silicon (amorphous or crystalline), silicon alloys, doped silicon, lithium titanate, composites thereof, and combinations thereof.

The first slurry mixture may comprise between about 2 wt. % and about 10 wt. % of the electro-conductive materials. The slurry mixture may comprise between about 4 wt. % and about 8 wt. % of the electro-conductive materials. The first slurry mixture may comprise between about 50-80 wt. % of solids with the solids comprising from about 1-20 wt. % of the electro-conductive materials. The slurry mixture may comprise between about 55-65 wt. % of solids with the solids comprising from about 2-10 wt. % of the electro-conductive materials.

Exemplary solvents include N-methyl pyrrolidone (NMP) and water.

The first slurry mixture may comprise between about 50-80 wt. % and solids and about 20-50 wt. % of the solvent. The first slurry mixture may comprise between about 55-65 wt. % of solids and about 35-45 wt. % of the solvent.

In certain implementations, the first slurry mixture has a high solids content of material. The first slurry mixture may have a high solids content of more than 30% by weight, more than 40% by weight, more than 50% by weight, more than 60% by weight, more than 70% by weight, more than 80% by weight, or more than 90% by weight based on the total weight percent of the first slurry mixture. The first slurry mixture may have a high solids content in the range of 30% to 95% by weight based on the total weight percent of the first slurry mixture. The first slurry mixture may have a high solids content in the range of 40% to 85% by weight based on the total weight percent of the first slurry mixture. The first slurry mixture may have a high solids content in the range of 50% to 70% by weight based on the total weight percent of the first slurry mixture. The first slurry mixture may have a high solids content in the range of 65% to 70% by weight based on the total weight percent of the first slurry mixture.

Optionally, after or during block 320, the first slurry mixture may be exposed to an optional drying process to remove liquids, for example, solvents, present in the slurry mixture. The first slurry mixture may be exposed to an optional drying process to remove any remaining solvents from the deposition process. The optional drying process may comprise but is not limited to drying processes such as an air drying process, for example, exposing the slurry mixture to a heated gas (e.g., heated nitrogen), a vacuum drying process, an infrared drying process, and heating the current collector on which the slurry mixture is deposited.

In certain implementations, the first slurry mixture may be exposed to the optional drying process during deposition of the material. For example, the conductive substrate/current collector 113 may be heated while the first slurry mixture is deposited over the substrate. Examples of simultaneous heating and deposition of materials are disclosed in commonly assigned United States Patent Application Publication No. US 2012/0219841, filed Feb. 22, 2012, to Bolandi et al and titled LITHIUM ION CELL DESIGN APPARATUS AND METHOD. The substrate may be heated to a temperature from about 80 degrees Celsius to about 180 degrees Celsius.

At block 330, a second slurry mixture comprising a cathodically active material is deposited on the first cathode material layer 210 to form a second cathode material layer 220. The second slurry mixture may be similar to the first slurry mixture as described herein. As described above with reference to the first slurry mixture, the second slurry mixture may comprise cathodically active materials and at least one of a binder, electro-conductive material and a solvent.

In certain implementations, the second slurry mixture and the first slurry mixture differ in liquid/solids content (e.g., solvent/cathode materials). In certain implementations where the slurry mixtures differ in liquid content, evaporation of the liquid leads to a difference in porosity between the first cathode material layer 210 and the second cathode material layer 220. For example, the first slurry mixture may have a liquid to solid ratio (by mass) of between about 1-0.25 and about 0.33-0.25 and the second slurry mixture may have a liquid to solids ratio of between about 1-0.25 and about 1-0.33. For example, the first slurry mixture may have a liquid to solid ratio (by mass) of between about 1:0.25 and about 0.33:0.25 and the second slurry mixture may have a liquid to solids ratio of between about 1:0.25 and about 1:0.33.

In certain implementations, the first cathode material layer 210 may have a solids content of greater than 60 wt. % and the second cathode material layer 220 may have a solids content of between about 50-60 wt. %. In certain implementations, the second cathode material layer 220 may have a solids content of greater than 60 wt. % and the first cathode material layer 210 may have a solids content of between about 50-60 wt. %.

The second slurry mixture may comprise between about 50 wt. % and about 80 wt. % of the solids. The second slurry mixture may comprise between about 55 wt. % and about 65 wt. % of the solids. The solids in the second slurry mixture may comprise between about 75 wt. % and about 98 wt. % of the cathodically active material. The solids in the second slurry mixture may comprise between about 85 wt. % and about 95 wt. % of the cathodically active material. The solids in the second slurry mixture may comprise between about 1 wt. % and about 10 wt. % of the binding agent. The solids in the second slurry mixture may comprise between about 1 wt. % and about 4 wt. % of the binding agent. The solids in the second slurry mixture may comprise between about 1 wt. % and about 20 wt. % of the electro-conductive materials. The solids in the second slurry mixture may comprise between about 2 wt. % and about 10 wt. % of the electro-conductive materials. The second slurry mixture may comprise between about 20 wt. % and about 50 wt. % of the solvent. The second slurry mixture may comprise between about 35 wt. % and about 45 wt. % of the solvent.

Optionally, after block 330, the second slurry mixture may be exposed to an optional drying process to remove liquids, for example, solvents, present in the slurry mixture. The second slurry mixture may be exposed to an optional drying process to remove any remaining solvents from the deposition process. The optional drying process may comprise but is not limited to drying processes such as an air drying process, for example, exposing the slurry mixture to at least one of a heated gas (e.g., heated nitrogen), a vacuum drying process, an infrared drying process, and heating the current collector on which the slurry mixture is deposited. In certain implementations, both the first slurry mixture and the second slurry may be dried simultaneously.

In certain implementations, the second slurry mixture may be exposed to the optional drying process during deposition of the material. For example, the conductive substrate/current collector 113 and the deposited first slurry mixture or first cathode material layer 210 may be heated while the second slurry mixture is deposited over the substrate. The substrate may be heated to a temperature from about 80 degrees Celsius to about 180 degrees Celsius.

After drying, the first cathode material layer 210 may have a porosity between about 40 and about 75. In certain implementations, the porosity of the first cathode material layer 210 is greater than the porosity of the second cathode material layer 220. In certain implementations, the first cathode material layer 210 has a porosity of at least 40% or 45%. In certain implementations, the first cathode material layer 210 has a porosity up to 45% or 50%. In one implementation, the porosity of the first cathode material layer 210 is between about 40% and about 50% as compared to a solid film formed from the same material and the porosity of the second cathode material layer 220 is between about 30% and about 35% as compared to a solid film formed from the same material.

At block 340, the as-deposited first cathode material layer 210 and the second cathode material layer 220 are compressed to achieve a desired porosity. In some implementations a pressure from about 2,000 to 7,000 psi is applied to the cathode material layers during the compression process. The cathode material layers deposited over the conductive substrate may be compressed using compression techniques, for example, a calendering process, to achieve a desired net density of compacted particles while planarizing the surface of the layer.

In certain implementations, the first cathode material layer 210 after compression has a porosity greater than the porosity of the second cathode material layer 220. In certain implementations, the first cathode material layer 210 has a porosity of at least 15%. In certain implementations, the first cathode material layer 210 has a porosity up to 35%. In certain implementations, the porosity of the first cathode material layer 210 is between about 15% and about 35% as compared to a solid film formed from the same material and the porosity of the second cathode material layer 220 is between about 30% and about 55% as compared to a solid film formed from the same material. In certain implementations, the porosity of the first cathode material layer 210 is between about 18% and about 27% as compared to a solid film formed from the same material and the porosity of the second cathode material layer 220 is between about 37% and about 50% as compared to a solid film formed from the same material.

In certain implementations, the porosity of the first cathode material layer 210 is less than the porosity of the second cathode material layer 220. In certain implementations, the porosity of the second cathode material layer 220 is between about 15% and about 35% as compared to a solid film formed from the same material and the porosity of the first cathode material layer 210 is between about 30% and about 55% as compared to a solid film formed from the same material. In certain implementations, the porosity of the second cathode material layer 220 is between about 18% and about 27% as compared to a solid film formed from the same material and the porosity of the first cathode material layer 210 is between about 37% and about 50% as compared to a solid film formed from the same material.

In certain implementations, the cathodically active material of the first cathode material layer 210 and the cathodically active material of the second cathode material layer 220 are identical materials. In certain implementations, the cathodically active material of the first cathode material layer 210 and the cathodically active material of the second cathode material layer 220 are different materials selected to vary the properties of each layer. In certain implementations, where different cathodically active materials are used for each layer, the cathodically active materials have different particle sizes which allow for easier packing of the particles to achieve a desired density/porosity in each individual layer using a single compression process.

In certain implementations, the average particle size of the cathodically active material of the first layer 210 and the average particle size of the cathodically active material of the second layer 220 are similar. In certain implementations, the average particle size of the cathodically active material of the first layer 210 and the average particle size of the cathodically active material of the second layer 220 are different. In certain implementations, the cathodically active material of the first cathode material layer 210 and the cathodically active material of the second cathode material layer 220 comprise the same material with different particle size. The difference in average particle size leads to different surface areas and/or different porosities for each layer.

In certain implementations, different modal particle size distributions (e.g., uni-modal, bi-modal, and multi-modal) may be used for each layer of active material relative to the other layers of active material present. The utilization of different modal particle size distributions in each layer allows for easier packing of the particles to achieve a desired density/porosity in each individual layer using a single compression process. For example, in certain implementations, the first cathode material layer 210 has a uni-modal particle size distribution and the second cathode material layer 220 has a bi-modal particle size distribution. In certain implementations, the first cathode material layer 210 has a bi-modal or multi-modal particle size distribution and the second cathode material layer 220 has a uni-modal particle size distribution. Exemplary average particle diameters for the uni-modal and bi-modal particle sizes include 3 microns, 6 microns, and 10 microns.

In certain implementations, the first slurry mixture and the second slurry mixture are deposited using the same deposition techniques. For example, the first slurry mixture and the second slurry mixture may be deposited using doctor blade techniques or electro-spray techniques. In certain implementations, the first slurry mixture and the second slurry mixture may be deposited using different deposition techniques. For example, the first slurry mixture may be deposited using doctor blading techniques and the second slurry mixture may be deposited using electro-spray techniques.

In certain implementations, a multi-layer cathode electrode wherein each layer comprises cathodically active materials having a different tap density than the tap density of the cathodically active materials of the other layers. In certain implementations, the first cathode material layer 210 comprises cathodically active material having a tap density between about 2 g/cm³ and about 3 g/cm³. In certain implementations, the second cathode material layer 220 comprises material having a tap density between about 2 g/cm³ and about 3 g/cm³. In certain implementations, the first cathode material layer 210 comprises cathodically active material having an average particle size of about 3 μm and a tap density of about 2.5 g/cm³ and the second cathode material layer 220 comprises cathodically active material having an average particle size of about 10 μm and a tap density of about 2.8 g/cm³. In certain implementations, the first cathode material layer 210 comprises cathodically active material having an average particle size of about 10 microns and a tap density of about 2.8 g/cm³ and the second cathode material layer 220 comprises cathodically active material having an average particle size of about 3 microns and a tap density of about 2.5 g/cm³. Typically smaller particles have a higher surface area per gram of material and hence are expected to have higher porosity. It is believed that higher tap density makes low porosity possible.

### Exemplary Structure:

(A) In one implementation, the first cathode material layer 210 of cathode structure 103 is the “energy layer” having a high packing density to achieve ultra-low electrode porosity (e.g., 15 to 20% porosity). The first cathode material layer 210 comprises LiCoO₂ having an average particle size from about 8 microns to about 25 microns. The first cathode material layer 210 may have an average thickness from about 1 to 80 microns. The second cathode material layer 220 is the “power layer” and has a porosity from about 30% to about 60%. The second cathode material layer 220 may comprise NMC, LiFePO₄, or LiMn₂O₄ having a particle size from about 1 to about 6 microns. The second cathode material layer 220 may have a thickness from about 10 to 80 microns. In some implementations, the thickness ratio of the first cathode material layer 210 to the second cathode material layer 220 is between about 5:1 to 1:5.

(B) In one implementation, a multi-layer electrode structure containing between two and twenty layers of cathode material similar to (A) is provided. The multi-layer electrode structure may contain between two and twenty layers and have a total electrode thickness from about 50 to 200 microns. The multi-layer electrode structure may have graded porosity. For example, in one implementation, the layers of the multi-layer electrode structure may be deposited such that the density of the cathode material is greatest adjacent to the current collector 113 (e.g., the first cathode material layer 210) and the density of the cathode material decreases with each layer deposited. In some implementations, the layers of the multi-layer electrode structure may be deposited such that the density of the cathode material is least adjacent to the current collector 113 (e.g., the first cathode material layer 210) and the density of the cathode material increases with each layer deposited.

(C) In certain implementations, the multi-layer electrode structure in part A may be deposited as follows: the first cathode material layer 210 may be deposited using an electro-spray process followed by a calendering process and the second cathode material layer 220 may be deposited using a slot die process. In some implementations, the second cathode material layer 220 may also be calendered.

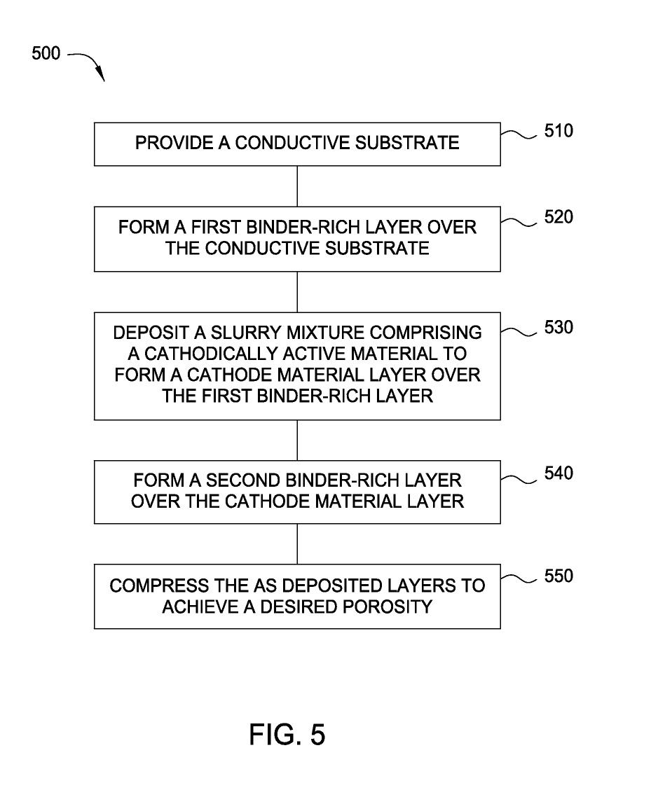

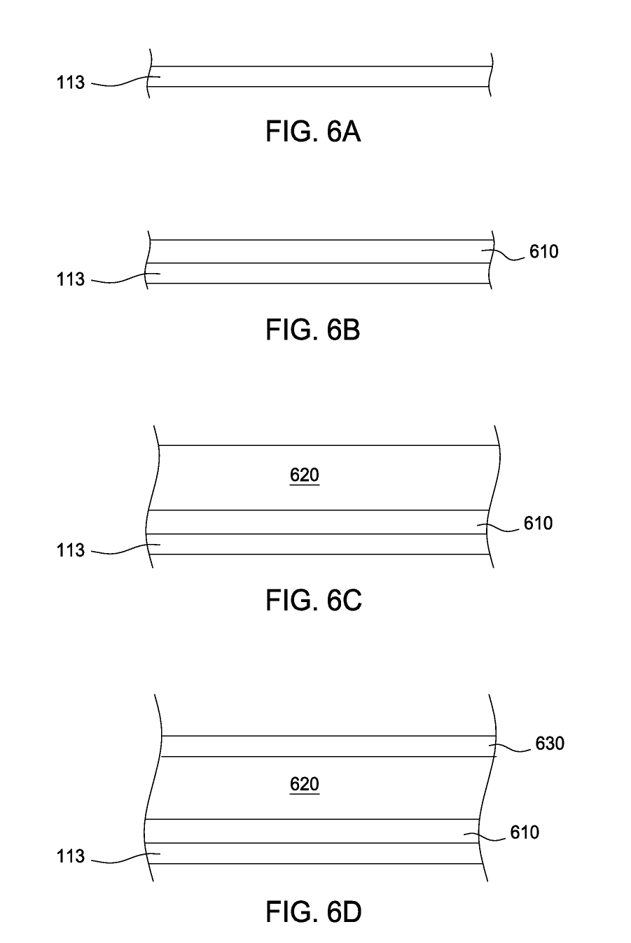

FIGS. 4A-4D are schematic cross-sectional views of another implementation of a partial multi-layer cathode electrode structure 403 formed according to implementations described herein. FIG. 5 is a process flow chart 500 summarizing one implementation of a method for forming a multi-layer cathode electrode structure according to implementations described herein. The multi-layer electrode structure 103 of FIGS. 4A-4D will be discussed with reference to the process flow chart 500.

At block 510, a conductive substrate is provided. The conductive substrate may be similar to current collector 113 as described above with reference to block 310 of flow chart 300. As depicted in FIG. 4A, the current collector 113 is schematically illustrated prior to the deposition of the multi-layer cathode material 402 on the current collector 113.

At block 520 a first binder-rich layer 410 is formed over the conductive substrate. The first-binder rich layer 410 helps the first cathode material layer adhere to the current collector 113. The first binder-rich layer 410 may be formed by depositing a slurry mixture using any of the deposition techniques described herein. The slurry mixture for forming the first binder-rich layer 410 may be similar to the slurry mixtures described herein for depositing first cathode material layer 210 and second cathode material layer 220 described above. The slurry mixture for forming the first binder-rich layer 410 may comprise cathodically active materials, a binder, and at least one of electro-conductive material and a solvent. The first binder-rich layer 410 typically comprises greater than 4.2 wt. % of binder.

In one implementation, the first binder-rich layer 410 has a thickness between about 30 μm to about 100 μm. In one implementation, the first binder-rich layer 410 has a thickness between about 40 μm to about 65 μm. The first binder-rich layer 410 may have a porosity between about 15% and about 35% as compared to a solid film formed from the same material. The first binder-rich layer 410 may have a porosity between about 18% and about 27% as compared to a solid film formed from the same material.

At block 530 a slurry mixture comprising a cathodically active material is deposited over the binder-rich layer 410 to form a first cathode material layer 420. The first cathode material layer 420 may be similar to either of first cathode material layer 210 or second cathode material layer 220 described above. The first cathode material layer 420 may be formed by depositing a slurry mixture using any of the deposition techniques described herein. The slurry mixture for forming the first cathode material layer 420 may be similar to the slurry mixtures described herein for depositing first cathode material layer 210 and second cathode material layer 220 described above.

In certain implementations, the first binder-rich layer 410 and the first cathode material layer 420 may be formed from the same deposited layer. For example, a single layer may be deposited on the current collector 113 using a slurry mixture and the binder is allowed to settle toward the bottom of the as-deposited single layer to form a binder-rich portion at the bottom of the single layer.

In one implementation, the first cathode material layer 420 has a thickness between about 30 μm to about 100 μm. In one implementation, the first cathode material layer 420 has a thickness between about 40 μm to about 65 μm. The first cathode material layer 420 may have a porosity between about 15% and about 35% as compared to a solid film formed from the same material. The first cathode material layer 420 may have a porosity between about 18% and about 27% as compared to a solid film formed from the same material.

At block 540 a second binder-rich layer 430 is formed over the first cathode material layer 420. The second binder-rich layer 430 may be formed by depositing a slurry mixture using any of the deposition techniques described herein. The slurry mixture for forming the second binder-rich layer 430 may be similar to the slurry mixtures described herein for depositing the first layer 210 and the second layer 220 described above. Similar to the slurry mixture for forming the first binder-rich layer 410 the slurry mixture for forming the second binder-rich layer 430 may comprise cathodically active materials, a binder, and at least one of electro-conductive material and a solvent. The slurry mixture for forming the first binder-rich layer 420 typically comprises greater than 4.2 wt. % of binder.

In one implementation, the second binder-rich layer 430 has a thickness between about 30 μm to about 100 μm. In one implementation, the second binder-rich layer 430 has a thickness between about 60 μm to about 80 μm. The second binder-rich layer 430 may have a porosity between about 30% and about 55% as compared to a solid film formed from the same material. The second binder-rich layer 430 may have a porosity between about 35% and about 50% as compared to a solid film formed from the same material.

Optionally, after block any of blocks 520, 530 and 540 the slurry mixtures may be exposed to an optional drying process to remove liquids, for example, solvents, present in the slurry mixture. The second slurry mixture may be exposed to an optional drying process to remove any remaining solvents from the deposition process. The optional drying process may comprise but is not limited to drying processes such as an air drying process, for example, exposing the slurry mixture to at least one of a heated gas (e.g., heated nitrogen), a vacuum drying process, an infrared drying process, and heating the current collector on which the slurry mixture is deposited. In certain implementations, the slurry mixtures may be dried simultaneously.

At block 550, the as-deposited first binder-rich layer 410, the cathode material layer 420, and the second binder-rich layer 430 are compressed to achieve a desired porosity. After the particles are deposited over the conductive substrate, the particles may be compressed using compression techniques, for example, a calendering process, to achieve a desired net density of compacted particles while planarizing the surface of the layer. In some implementations a pressure from about 2,000 to 7,000 psi is applied to the cathode material layers during the compression process.

In certain implementations, the first cathode material layer 420 after compression has a porosity of at least 15%. In certain implementations, the first cathode material layer 420 has a porosity up to 35%. In certain implementations, the porosity of the first cathode material layer 420 is between about 15% and about 35% as compared to a solid film formed from the same material and the porosity of the second layer is between about 30% and about 55% as compared to a solid film formed from the same material. In certain implementations, the porosity of the first cathode material layer 420 is between about 18% and about 27% as compared to a solid film formed from the same material and the porosity of the second layer is between about 37% and about 50% as compared to a solid film formed from the same material.

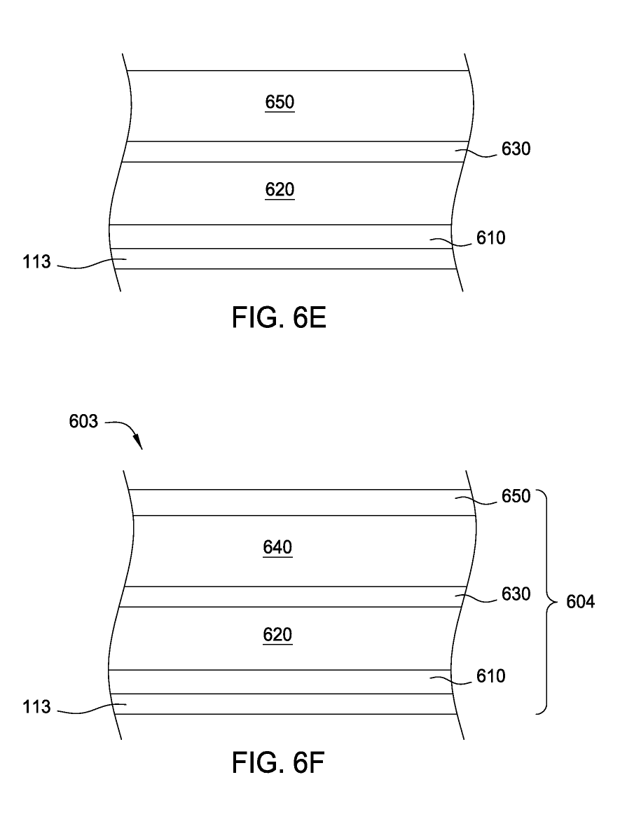

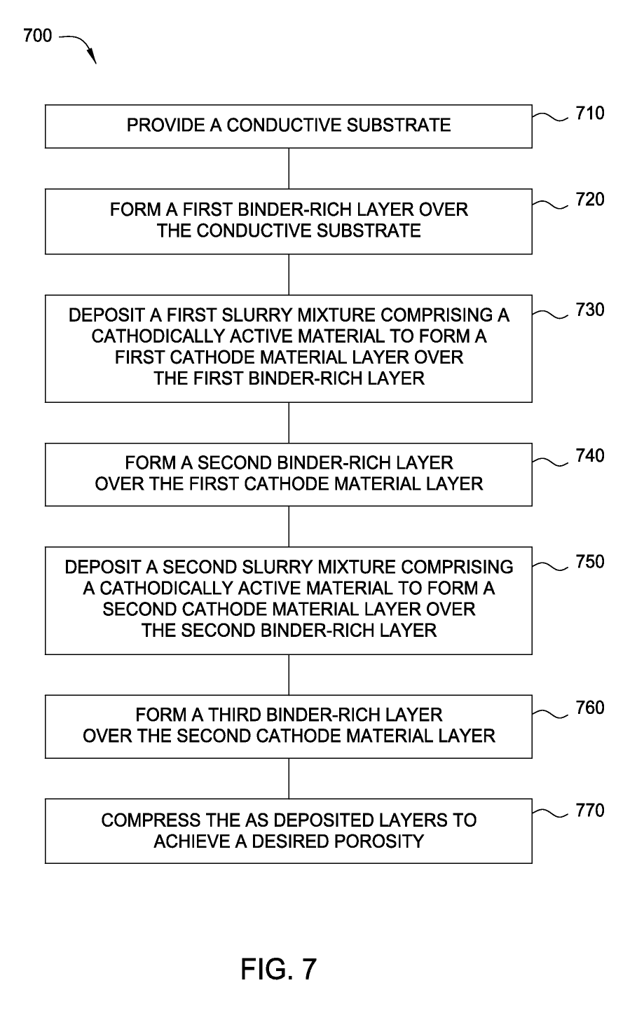

FIGS. 6A-6F are schematic cross-sectional views of one implementation of a partial multi-layer cathode electrode structure 603 formed according to implementations described herein. FIG. 7 is a process flow chart 700 summarizing one implementation of a method for forming a multi-layer cathode electrode structure according to implementations described herein. The multi-layer electrode structure 103 of FIGS. 6A-6F will be discussed with reference to the process flow chart 700.

At block 710 a conductive substrate is provided. The conductive substrate may be similar to current collector 113 as described above with reference to block 310 of flow chart 300. As depicted in FIG. 6A, the current collector 113 is schematically illustrated prior to the deposition of the multi-layer cathode material 604 on the current collector 113.

At block 720 a first binder-rich layer 610 is formed over the conductive substrate. The first binder-rich layer 610 may be formed by depositing a slurry mixture using any of the deposition techniques described herein. The slurry mixture for forming the first binder-rich layer 610 may be similar to the slurry mixtures described herein for depositing the first binder-rich layer 410, the first cathode material layer 210 and second cathode material layer 220 described above. The slurry mixture for forming the first binder-rich layer 610 may comprise cathodically active materials, a binder, and at least one of electro-conductive material and a solvent. The slurry mixture for forming the first binder-rich layer 610 typically comprises greater than 4.2 wt. % of binder.

In one implementation, the first binder-rich layer 610 has a thickness between about 30 μm to about 100 μm. In one implementation, the first binder-rich layer 610 has a thickness between about 40 μm to about 65 μm. The first binder-rich layer 610 may have a porosity between about 15% and about 35% as compared to a solid film formed from the same material. The first binder-rich layer 610 may have a porosity between about 18% and about 27% as compared to a solid film formed from the same material.

At block 730 a first slurry mixture comprising a cathodically active material is deposited over the first binder-rich layer 610 to form a first cathode material layer 620 on the first binder-rich layer 610. The first cathode material layer 620 may be similar to either of the first cathode material layer 210 or the second cathode material layer 220 described above. The first cathode material layer 620 may be formed by depositing a slurry mixture using any of the deposition techniques described herein. The slurry mixture for forming the first cathode material layer 620 may be similar to the slurry mixtures described herein for depositing the first cathode material layer 210 and the second cathode material layer 220 described above.

As described above with reference to the binder-rich layer 410 and the first cathode material layer 420, the first binder-rich layer 610 and first cathode material layer 620 may be formed from the same deposited layer.

In one implementation, the first cathode material layer 620 has a thickness between about 30 μm to about 100 μm. In one implementation, the first cathode material layer 620 has a thickness between about 40 μm to about 65 μm. The first cathode material layer 620 may have a porosity between about 15% and about 35% as compared to a solid film formed from the same material. The first cathode material layer 620 may have a porosity between about 18% and about 27% as compared to a solid film formed from the same material.

At block 740 a second binder-rich layer 630 is formed over the first cathode material layer 620. The second binder-rich layer 630 provides stability and helps prevent delamination between the first cathode material layer 620 and the second cathode material layer 640. The second binder-rich layer 630 may be formed by depositing a slurry mixture using any of the deposition techniques described herein. The slurry mixture for forming the second binder-rich layer 630 may be similar to the slurry mixtures described herein for depositing the first cathode material layer 210 and the second cathode material layer 220 described above. Similar to the slurry mixture for forming the first binder-rich layer 610 the slurry mixture for forming the second binder-rich layer 630 may comprise cathodically active materials, a binder, and at least one of electro-conductive material and a solvent. The second binder-rich layer 630 typically comprises greater than 4.2 wt. of binder.

In one implementation, the second binder-rich layer 630 has a thickness between about 30 μm to about 100 μm. In one implementation, the second binder-rich layer 630 has a thickness between about 40 μm to about 65 μm. The second binder-rich layer 630 may have a porosity between about 15% and about 35% as compared to a solid film formed from the same material. The second binder-rich layer 630 may have a porosity between about 18% and about 27% as compared to a solid film formed from the same material.

At block 750, a second slurry mixture is deposited over the second binder-rich layer 630 to form a second cathode material layer 640 over the second binder-rich layer 630. The second cathode material layer 640 may be formed by depositing a slurry mixture using any of the deposition techniques described herein. The second slurry mixture may be similar to the first slurry mixture described above. As described above with reference to the first slurry mixture, the second slurry mixture may comprise cathodically active materials and at least one of a binder, electro-conductive material and a solvent.

In one implementation, the second cathode material layer 640 has a thickness between about 30 μm to about 100 μm. In one implementation, the second cathode material layer 640 has a thickness between about 40 μm to about 65 μm. The second cathode material layer 640 may have a porosity between about 15% and about 35% as compared to a solid film formed from the same material. The second cathode material layer 640 may have a porosity between about 18% and about 27% as compared to a solid film formed from the same material.

In certain implementations, the first cathode material layer 210 may differ from the second cathode material layer 220 in any of the following: different slurry compositions in each layer leading to different porosities between the layers, different active materials in each layer, different particle size of the same active material in each layer leading to different surface areas and/or different porosities between the layers, different particle size distribution (e.g., uni-modal, bi-modal, multi-modal) between the layers, different electrode compositions (binder, conductive additive, active material) in each layer, and different tap densities.

At block 760, a third binder-rich layer 650 is formed over the second cathode material layer 640. The third binder-rich layer 650 may be formed by depositing a slurry mixture using any of the deposition techniques described herein. The slurry mixture for forming the third binder-rich layer 650 may be similar to the slurry mixtures described herein for depositing the first cathode material layer 210 and the second cathode material layer 220 described above. Similar to the slurry mixture for forming the first binder-rich layer 610 the slurry mixture for forming the third binder-rich layer 650 may comprise cathodically active materials, a binder, and at least one of electro-conductive material and a solvent. The slurry mixture for forming the third binder-rich layer 650 typically comprises greater than 4.2 wt. % of binder.

In one implementation, the third binder-rich layer 650 has a thickness between about 30 μm to about 100 μm. In one implementation, the third binder-rich layer 650 has a thickness between about 40 μm to about 65 μm. The third binder-rich layer 650 may have a porosity between about 15% and about 35% as compared to a solid film formed from the same material. The third binder-rich layer 650 may have a porosity between about 18% and about 27% as compared to a solid film formed from the same material.

Optionally, after block any of blocks 720, 730, 740, 750, 760, and 770 the slurry mixtures may be exposed to an optional drying process to remove liquids, for example, solvents, present in the slurry mixture. The second slurry mixture may be exposed to an optional drying process to remove any remaining solvents from the deposition process. The optional drying process may comprise but is not limited to drying processes such as an air drying process, for example, exposing the slurry mixture to at least one of a heated gas (e.g., heated nitrogen), a vacuum drying process, an infrared drying process, and heating the current collector on which the slurry mixture is deposited. In certain implementations, both the slurry mixtures may be dried simultaneously.

At block 770, the first binder-rich layer 610, the first cathode material layer 620, the second-binder-rich layer 630, the second cathode material layer 640 and the third binder-rich layer 650 are compressed to achieve a desired porosity. After the particles are deposited over the conductive substrate, the particles may be compressed using compression techniques, for example, a calendering process, to achieve a desired net density of compacted particles while planarizing the surface of the layer. In some implementations a pressure from about 2,000 to 7,000 psi is applied to the cathode material layers during the compression process.

In certain implementations, the first cathode material layer 620 after compression has a porosity greater than the porosity of the second cathode material layer 640. In certain implementations, after compression, the porosity of the first cathode material layer 620 is less than the porosity of the second cathode material layer 640.

### EXAMPLES

The following non-limiting examples are provided to further illustrate implementations described herein. However, the examples are not intended to be all inclusive and are not intended to limit the scope of the implementations described herein.

A first and second slurry composition having 65 wt. % solid content and comprising 4 wt. % PVDF, 3.2 wt. % carbon black (CB), and 92.8 wt. % lithium nickel-manganese-cobalt oxide (NMC) was used for the following examples. The NMC labeled MX-3 had an average particle size of 3 microns and the NMC labeled MX-10 had an average particle size of 10 microns. Both slurry compositions contained NMC as the cathodically active material.

### Examples B0507-1 thru B0507-3

For examples B0507-1 thru B0507-3 a first slurry mixture having MX-10 was deposited using a doctor blade process over an aluminum foil current collector having a thickness of 18.5 microns. The aluminum foil current collector and first slurry mixture were heated to 80 degrees Celsius to evaporate off solvent and form a first cathode material layer. A second slurry mixture having MX-3 was deposited over the first cathode material layer. The aluminum foil current collector, first cathode material layer and second slurry mixture were heated to 80 degrees Celsius to evaporate off solvent and form a second cathode material layer. The first cathode material layer and the second cathode material layer were exposed to a single calendering process at a pressure of between 2,000 and 7,000 psi. The first cathode material layer had a final thickness of 65.8 microns and a final porosity of 36%. The second cathode material layer had a final thickness of 97.6 microns and a final porosity of 42%.

### Examples B0508-1 thru B0508-3

For examples B0508-1 thru B05087-3 a first slurry mixture having MX-3 was deposited using a doctor blade process over an aluminum foil current collector having a thickness of 18.8 microns. The aluminum foil current collector and first slurry mixture were heated to 80 degrees Celsius to evaporate off solvent and form a first cathode material layer. A second slurry mixture having MX-10 was deposited over the first cathode material layer. The aluminum foil current collector, first cathode material layer and second slurry mixture were heated to 80 degrees Celsius to evaporate off solvent and form a second cathode material layer. The first cathode material layer and the second cathode material layer were exposed to a single calendering process at a pressure of between 2,000 and 7,000 psi. The first cathode material layer had a final thickness of 64.6 microns and a final porosity of 38%. The second cathode material layer had a final thickness of 110 microns and a final porosity of 34%.

Results:

TABLE I

| | | C/10 (Cyc#2) | 2/3C (Cyc#8) | | 1C (Cyc#10) | | 2C (Cyc#12) | |
|---|---|---|---|---|---|---|---|---|
| | Sample | Loading | Loading | Retention | Loading | Retention | Loading | Retention |
| | ID | (mAh/cm2) | (mAh/cm2) | (%) | (mAh/cm2) | (%) | (mAh/cm2) | (%) |
| MX10/ | B0507-1 | 5.88 | 4.92 | 83.7 | 3.86 | 65.6 | 2.02 | 34.4 |
| MX3 | B0507-2 | 5.98 | 5.21 | 87.1 | 4.23 | 70.7 | 2.31 | 38.6 |
| | B0507-3 | 6.06 | 4.95 | 81.7 | 3.89 | 64.2 | 1.92 | 31.7 |
| MX3/ | B0508-1 | 6.2 | 4.79 | 77.3 | 3.50 | 56.5 | 1.57 | 25.3 |
| MX10 | B0508-2 | 6.03 | 4.82 | 79.9 | 3.58 | 59.4 | 1.66 | 27.5 |
| | B0508-3 | 6.00 | 4.93 | 82.2 | 3.67 | 61.2 | 1.61 | 26.8 |

While the foregoing is directed to implementations of the present invention, other and further implementations of the invention may be devised without departing from the basic scope thereof, and the scope thereof is determined by the claims that follow.

1. A method for forming a multi-layer cathode structure, comprising:
providing a conductive substrate;
depositing a first slurry mixture comprising a cathodically active material to form a first cathode material layer over the conductive substrate;
depositing a second slurry mixture comprising a cathodically active material to form a second cathode material layer over the first cathode material layer; and
compressing the as-deposited first cathode material layer and the second cathode material layer to achieve a desired porosity.

2. The method of claim 1, wherein the first slurry mixture and the second slurry mixture each independently comprise:
a cathodically active material; and
at least one of a binding agent, a binding precursors, an electro-conductive material and a solvent.

3. The method of claim 1, wherein a solids content of the first slurry mixture is different than a solids content of the second slurry mixture.

4. The method of claim 2, wherein a tap density of the cathodically active material of the first slurry mixture differs from a tap density of the cathodically active material of the second slurry mixture.

5. The method of claim 4, wherein the cathodically active material of the first slurry mixture differs from the cathodically active material of the second slurry mixture.

6. The method of claim 4, wherein the wt. % of binding agent in the first slurry mixture differs from the wt. % of binding agent in the second slurry mixture.

7. The method of claim 4, wherein the particle size distribution of the first slurry mixture differs from the particle size distribution of the second slurry mixture.

8. The method of claim 7, wherein the particle size distribution of the first slurry mixture and the particle size distribution of the second slurry mixture are each independently selected from uni-modal particle size distribution, bi-modal particle size distribution, and multi-modal particle size distribution.

9. The method of claim 4, wherein compressing the as-deposited first cathode material layer and the second cathode material layer to achieve a desired porosity comprises calendering the as-deposited layers.

10. The method of claim 4, wherein the conductive substrate comprises aluminum.

11. The method of claim 4, wherein the cathodically active material of the first slurry mixture and the cathodically active material of the second slurry mixture are each independently selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

12. The method of claim 4, wherein the binding agent is selected from the group comprising: polyvinylidene fluoride (PVDF), styrene butadiene rubber (SBR), carboxymethylcellulose (CMC), and combinations thereof.

13. The method of claim 4, wherein the cathodically active material of the first slurry mixture comprises particles having a first average diameter and the cathodically active material of the second slurry mixture comprises particles having a second average diameter, wherein the second average diameter is greater than the first average diameter.

14. The method of claim 13, wherein the first average diameter is between about 2 μm and about 15 μm and the second average diameter is between about 5 μm and about 15 μm.

15. The method of claim 13, wherein the second average diameter is between about 2 μm and about 15 μm and the first average diameter is between about 5 μm and about 15 μm.
